(19) United States
(12) Patent Application Publication
(10) Pub. No.: US 2007/0014658 A1
(43) Pub. Date: Jan. 18, 2007

(54) Vertical axis wind mill with variable pitch flat blades and booster curtains

(76) Inventor: Sid S. Mollinger, Laval (CA)

Correspondence Address: SID S. MOLLINGER, 4115 - 9th STR., LAVAL, QC, H7W 1Y2, CA

(21) Appl. No.: 11/178,558

(22) Filed: Jul. 12, 2005

(51) Int. Cl. F03D 7/06

(52) U.S. Cl. 415/4.2

(57) ABSTRACT

A vertical axis wind mill with variable pitch flat blades and booster curtains that are all moved by electrical motors which are controlled by a weather vane.

The present invention relates to a vertical axis wind mill having variable pitch flat blades and booster curtains attached to the ends of radial arms. Present practice for wind energy converters is to use horizontal axis propeller type wind turbines with the generator at the same difficult to service elevation as the propeller. These wind turbines have a relatively low efficiency and are self-starting at wind speeds of only 15 to 20 km/hr. some only at 30 km/hr or even higher wind speed. The present invention makes the most of the fact that work is the product of force time lever arm. Wind blowing on a large flat area that is attached to an vertical shaft exerts a substantial torque on the shaft. This principle is applied in the present invention by using variable pitch flat blades and booster curtains attached to the ends of structural arms that extend radially from a vertical shaft and rigidly connected thereto thus creating a torque on the vertical shaft. The vertical shaft is guyed to the ground using a slip collar and guy wires for lateral stability and it has at the bottom a large sprocket wheel rigidly attached to it which transfers the torque to a small sprocket wheel of a generator. The generator is thus easily accessible at or below ground level. A considerable advantage over conventional wind turbines, Also, most parts of such relatively simple wind mill can be made by steel fabricators anywhere.

The arrangement presented four problems which had to be solved in an inventive way. They are:
a) The manner in which the structure is stabilized,
b) how, when, where and at what rate the pitch of the flat blades is to be changed to attain best efficiency,
c) the use of booster curtains,
d) how, when and where the booster curtains are to be lowered and raised.

Having thus generally described the nature of the invention, reference is made to the accompanying drawings showing by way of an example specific embodiments thereof and in which

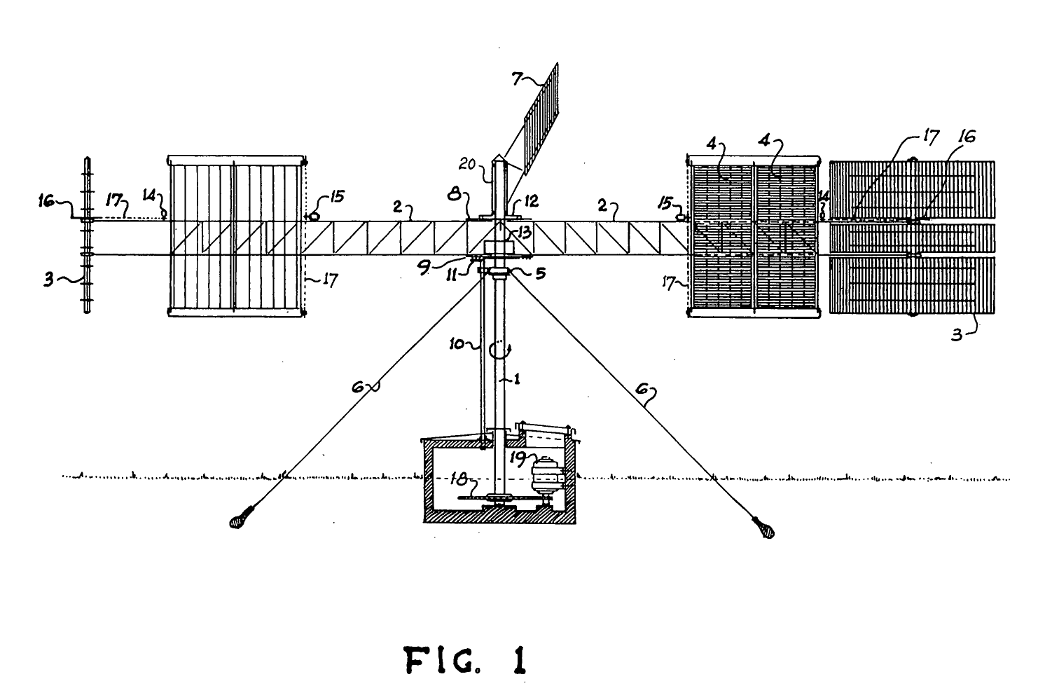

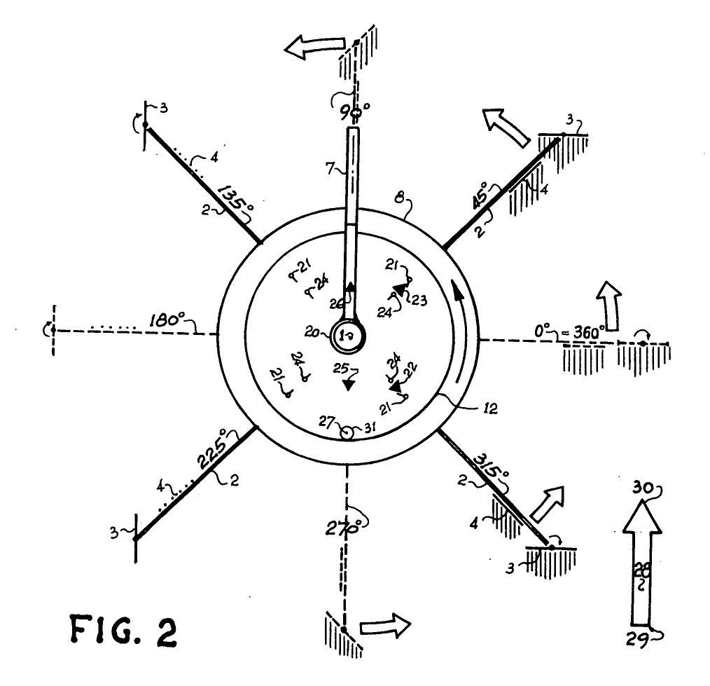

FIG. 1 is an elevation of the vertical axis wind mill with a right hand arm at the 0 position and the opposite arm at the 180 degree position of a circle in a plan view as shown in dotted lines in FIG. 2.

FIG. 2 is a plan view showing in diagrammatic way the radial arms, the weather vane, the motor control switches for blade pitch and curtain control, the motor speed and direction control device, the direction of the wind and the pitch of the flat blades to be attained at various positions of the radial arms.

The following reference characters are used

| | |
|---|---|
| 1 | vertical shaft |
| 2 | radial arm |
| 3 | variable pitch, three |
| | section, flat blade |
| 4 | booster curtain |
| 5 | slip collar |
| 6 | guy wire |
| 7 | weather vane |
| 8 | top circular steel plate |
| | with motor control switches |
| 9 | bottom circular steel plate |
| | with power pick-up rings |
| 10 | external power supply |
| | conduit |
| 11 | power pick-up rings |
| 12 | circular cover plate with |
| | switch actuators, a rim and |
| | perimeter seal |
| 13 | motor control box |
| 14 | variable speed, bi-directional |
| | electric motor, moving pitch |
| | of blades |
| 15 | bi-directional electric motor |
| | raising or lowering booster |
| | curtains |
| 16 | sprocket wheel or sheave |
| 17 | drive chain or belt |
| 18 | large diameter sprocket wheel |
| 19 | generator |
| 20 | sleeve over vertical shaft |
| 21 | alternate on-off switch for |
| | pitch control motors |
| 22 | switch actuator for pitch control |
| | motors on arms at the |
| | 135 and 315 degree positions |
| 23 | switch actuator for pitch control |
| | motors on arms at the |
| | 45 and 225 degree positions |
| 24 | directional on-off switch |
| | for curtain control motor |
| 25 | directional on-off switch actuator |
| | for curtain control motor |
| | at position 270 |
| 26 | directional on-off switch actuator |
| | for curtain control motor |
| | at position 90 |
| 27 | speed and direction control device |
| | for pitch control motors14 |
| 28 | direction of wind |
| 29 | windward side |
| 30 | leeward side |
| 31 | small diameter wheel |

| | | |
|---|---|---|
| 0, 45, 90, 135, | | are positions of radial arms in degrees on a circle |
| 180, 225, 270, | {close oversize brace} | in plan view, where 0 is at the right |
| 315 and 360 | | hand side. |

FIG. 1 is to a large degree self explanatory to a structural or mechanical engineer. Variable pitch flat blades 3 need to be in three sections in order to use the area between the top and bottom chords of the truss-like radial arms 2. The three sections of blades 3 are rigidly attached to a vertical axis which is rotated by sprocket wheel or sheave 16 that is moved by a chain or belt 17 driven by motor 14. Booster curtains 4 are shown to be of the pull down type, rolled around a horizontal shaft at the top of a structural frame when open. Motor 15 will do both, raise or lower the curtains. The top and bottom chords of truss-like radial arms 2 are connected to vertically spaced apart top and bottom circular steel plates 8 and 9 respectively and these horizontal plates are rigidly attached to vertical shaft 1, thus transferring torque, vertical and lateral loads thereto. Lateral stability of the structure is attained by the solid attachment to vertical shaft 1 of a circular angle just below bottom steel plate 9, the placement of a slip collar 5 on top of the circular angle and the connection of four guy wires 6 at 90 degrees to the slip collar 5 and anchored to the ground. Slip collar 5 does not rotate.

A pipe-like sleeve 20 is placed over an extension on top of vertical shaft 1. On the side of that sleeve 20 is rigidly connected weather vane 7 and at the bottom a circular cover plate 12 with a rim and a perimeter seal to keep out rain, wind and ice from motor control switches that are located between cover plate 12 and top circular steel plate 8. Motors 14 and 15 need electric power which is supplied from generator 19 or a power grid via stationary conduit 10 to power pick-up rings 11 on the underside of the normally rotating bottom circular steel plate 9. At the bottom of vertical shaft 1 is attached a large diameter sprocket wheel 18 that drives a small diameter sprocket wheel of generator 19.

The example shown in diagrammatic fashion in FIG. 2 shows a wind mill with four radial arms 2 extending cross-like from the vertical shaft 1 but rotated by 45 degrees. In dotted lines is the preceding position when two arms were in the 0 to 180 degree direction to illustrate the pitch of flat blades 3 in the corresponding positions of the four arms. In the shown example the wind blows in the direction 28 i.e. from the bottom of the page to the top of the page, thus holding weather vane 7 on the leeward side 30 of vertical shaft 1 i.e. the 90 degree position and rotates the wind mill counterclockwise. This counterclockwise rotation of the wind mill is achieved by the force of the wind acting on flat blades 3 that are turned to such a pitch with respect to the radial arms 2 and by the booster curtains 4 so as to attain maximum counterclockwise torque substantially on the right hand side of the wind mill and near minimum resistance from the blades and the curtains when returning against the wind, substantially on the left hand side of the wind mill.

In the example shown in FIG. 2 the four radial arms are in a 45 degree diagonal position thus obtaining four 90 degree sections, one at the top in which weather vane 7 is exactly in the middle, one at the bottom, one at the right and one at the left side of a circle. These sections remain always aligned with weather vane 7 and are significant for the pitch control of flat blades 3 as follows. In the top and bottom 90 degree sections the pitch of flat blades 3 will not change. In other words, the 45 degree right slash pitch of flat blade 3 on radial arm 2 at the 45 degree position does not change until radial arm 2 reaches the 135 degree position. And in the bottom 90 degree section the 45 degree left slash pitch of flat blade 3 on radial arm 2 does not change until this radial arm 2 reaches the 315 degree position. In both, the left and right 90 degree sections the flat blades 3 will rotate clockwise by 90 degrees. In other words, when a radial arm reaches position 135 or position 315, the flat blades 3 will begin to rotate clockwise at a rate that by the time radial arms 2 reach position 45 or 225 flat blades 3 will have rotated clockwise by 90 degrees and then stop.

Booster curtain 4 on arm 2 that reache4s a position opposite weather vane 7 i.e. the 270 degree position, will be lowered i.e. closed. When the opposite arm 2 reaches the position under weather vane 7 i.e. the 90 degree position, booster curtain 4 on that arm will be raised i.e. opened. All the movements of flat blades 3 and booster curtains 4 are accomplished by electric motors 14 and 15 which are controlled by weather vane 7 in such a way that the relative positions of blades 3 and curtains 4 with regard to the weather vane 7 are always attained, no matter from what direction the wind is blowing.

At the bottom of sleeve 20 is attached a circular cover plate 12, the bottom of which is about one inch from the top of top circular steel plate 8. In this space of about one inch between these two horizontal plates are located eight switches, four switch actuators and a motor speed and direction control device. All positions mentioned hereafter are on a circle of 360 degrees and are relative to the position of weather vane 7 which is always at position 90 i.e. on the leeward side of vertical shaft 1. On top of top circular steel plate 8 are mounted four alternate on-off switches 21, one each on diagonals in the 45, 135, 225 and 315 degree position on a radius so as not to interfere with speed and direction control device 27. Also on top of top circular steel plate 8 are mounted four directional on-off switches 24, one each on the same diagonal positions as switches 21 but on a smaller radius so as not to interfere with switch actuators 22 and 23. In addition, on top of top circular steel plate 8 is mounted the axis of speed and direction control device 27 near the rim of circular cover plate 12 at the 270 degree position. Mounted to the underside of circular cover plate 12 are four switch actuators. Switch actuator 22 is attached at the diagonal 315 degree position on a radius so as to switch on alternate on-off switches 21 when they pass by. Switch actuator 23 is mounted at the 45 degree diagonal position on the same radius as switch actuator 22 so as to switch off alternate on-off switches 21 when they pass by when top circular steel plate 8 rotates. Directional on-off switch actuators 25 and 26 are mounted on the underside of circular cover plate 12 at the 270 and 90 degree positions respectively at a radius so as to switch on or off directional on-off switches 24 for curtain control motors. On the outside rim of circular cover plate 12 will be attached a seal so as to keep out rain, snow and ice. The seal will be in contact with top circular steel plate 8 producing some friction thus requiring a certain force to rotate cover plate 12. However, weather vane 7 will be of a size and have an arm of a length so that it will overcome the inertia at a wind speed of about 3 km/hr. All power to all electric motors will be switched off when the wheel of speed and direction control device 27 stops, i.e. when the wind mill as well as the weather vane 7 stop turning.

In the diagram as shown in FIG. 2 the wind blows in direction 28 or from position 270 to position 90 or from the bottom to the top of the page thus keeping weather vane 7 steady on the leeward 30 side of vertical shaft 1 and turning the wind mill and with it top circular steel plate 8 in a counterclockwise direction. When one radial arm 2 reaches position 315 and the opposing arm position 135 switch actuator 22 will trigger switch 21 to start two motors 14 so as to begin to rotate blade 3 on the extremity of each of these two arms in a clockwise direction. At the same time the other two radial arms 2 of a four arm wind mill will reach positions 45 and 225 when switch actuator 23 will trigger alternate on-off switch 21 to stop motors 14 and with them the rotation of blades 3 on these two arms 2. Since blade 3 at the end of arm 2 in position 315 is on a 45 degree backslash pitch with respect to arm 2 and blade 3 of arm 2 in position 45 is in a 4-5 degree forward slash pitch the clockwise rotation of blades 3 is by exactly 90 degrees between these two positions of arm 2. This is also the case for blade 3 on the opposite arm 2 between positions 135 and 225.

Since the perimeter speed of the wind mill under heavy wind conditions will be higher and therefore the time to rotate radial arms 2 by 90 degrees will be reduced while the clockwise rotation of blades 3 will still be by the required 90 degrees in a shorter time, it is necessary that motors 14 have controllable speed. Such control is coming from speed and direction control device 27, which operates in the following manner. The location of device 27 has been specified earlier. Device 27 consists of a small diameter shaft attached to the top of top circular steel plate 8 at such a position that a small diameter wheel 31 touches the rim of circular cover plate 12. Under normal operation the wind mill and top circular steel plate 8 turn in counterclockwise direction at a certain speed and weather vane 7 with circular cover plate 12 are stationary. This will turn the small wheel 31 of speed and direction control device 27 in a clockwise direction at a speed in a certain ratio to the perimeter speed of the wind mill. Device 27 can therefore send via motor control box 13 two signals to motors 14 i.e. in what direction to turn and at what speed.

In the case when the direction of the wind shifts so as to turn weather vane 7 in a clockwise direction it will have the effect of turning the small wheel 31 of speed and direction control device 27 faster in the same direction and device 27 will therefore send the signal to turn faster to the two motors 14 that are changing the pitch of blades 3.

In the case when the direction of the wind shifts so as to turn weather vane 7 in a counterclockwise direction it can have three different effects, depending on the speed at which weather vane 7 is rotated counterclockwise
a) When weather vane 7 rotates counterclockwise at less than the speed of the wind mill, which also rotates counterclockwise. In this case the small wheel 31 of speed and direction control device 27 will slow down, thus sending the signal to do the same to the two motors 14 that are on at that time.
b) When weather vane 7 rotates counterclockwise at the same speed as the wind mill, which also rotates counterclockwise. In this case the small wheel 31 of device 27 stops rotating, thus sending the signal to the two operating motors 14 to stop.
c) In the rare case when weather vane 7 rotates counterclockwise at greater speed than the wind mill, which also rotates counter-clockwise. In this case all pitch and booster curtain controls will work in reverse as switches will be triggered in reverse and the small wheel 31 of device 27 will rotate counterclockwise, thus sending the signal to the two motors 14 that are operating to rotate blades 3 counterclockwise at the specific speed that depends on the speed of the counterclockwise rotation of small wheel 31.

The embodiments of the invention in which an exclusive property or privilege is claimed are defined as follows

1. A wind mill having a vertical shaft from which radially extend four arms at right angle to each other, at the end of each of said four arms are attached a variable pitch, flat, three section blade mounted on a vertical axis and a booster curtain within a structural frame located next to said blade and whereby the pitch of said blade is changed by a variable speed bi-directional electric motor and the said booster curtain is opened or closed by a bi-directional electric motor and whereby the speed and direction of said electric motors are controlled by a weather vane so as to attain maximum torque on said vertical shaft from wind blowing from any horizontal direction.

2. A wind mill as claimed in claim 1 wherein each of said four radial arms is an assembly of two vertical and two horizontal trusses, said trusses being connected to two vertically spaced apart horizontal and circular steel plates that are centered on said vertical shaft and are rigidly connected near the top of and to said vertical shaft, thus transferring the torque and the lateral and vertical loads to said vertical shaft and wherein the lateral stability of the wind mill is attained by the use of a slip collar that is placed over a fixed collar that is rigidly attached to said vertical shaft just below the lower of said two vertically spaced apart horizontal and circular steel plates and whereby guy wires are attached to said slip collar and anchored to the ground.

3. A wind mill as claimed in claims 1 or 2 whereby said vertical shaft has an extension above said four radial arms so as to give vertical and lateral support to a directional assembly consisting of a pipe-like sleeve that is placed over said extension and whereby said weather vane is attached to the side of said pipe-like sleeve and at the bottom of said pipe-like sleeve is centrically attached at a vertical distance of about one inch from the top of the upper of said two vertically spaced apart horizontal and circular steel plates a horizontal circular cover plate with a rim and a seal around its perimeter and whereby on the underside of said horizontal circular cover plate are mounted two switch actuators at a predetermined distance from said vertical shaft, one of said two switch actuator sat an angle of 45 degrees, the other at an angle of 135 degrees towards the right of said weather vane when viewed in plan, and also on the underside of said horizontal circular cover plate are mounted two directional on-off switch actuators on a predetermined smaller distance from said vertical shaft, one of said two directional on-off switch actuators is located right under said weather vane, the other is located on the opposite side of said vertical shaft and whereby said directional assembly is rotating when the wind changes direction so that the said weather vane is always on the leeward side of said vertical shaft.

4. A wind mill as claimed in claims 2 and 3 whereby an arrangement of eight switches and a motor speed and direction control device interact with said directional assembly to operate the said blades and the said booster curtains at best efficiency and wherein on top of said two vertically spaced apart horizontal and circular steel plates are mounted a first set of four alternate on-off switches, one each over the axis of said four radial arms on a corresponding radius so as to be engaged by said two switch actuators when passing by, and are mounted a second set of four directional on-off switches, one each over the axis of said four radial arms on a corresponding shorter radius so as to be engaged by said two directional on-off switch actuators when passing by, and is mounted near the said rim of said horizontal circular cover plate said motor speed and direction control device consisting of a short shaft and a small diameter wheel that is in contact with said rim of said horizontal circular cover plate.

5. A wind mill as claimed in claims 3 and 4 whereby in a plan view the said four radial arms rotate in a circle of 360 degrees or 360 positions around said vertical shaft and zero degrees or position zero being on the right hand side of a horizontal circle and the wind blowing from position 270 to position 90 thus holding the said weather vane at position 90 and whereby the said blades produce a maximum counterclock-wise torque on said vertical shaft by virtue of said pitch of said blades and whereby said pitch remains unchanged in a 45 degree right slash direction with respect to said radial arms from position 45 to position 135 and remains unchanged in a 45 degree backslash direction with respect to said radial arms from position 225 to position 315 and when at position 315 the other of said two switch actuators will trigger one of said four alternate on-off switches located over position 315 to start two of said variable speed bi-directional electric motors, one at position 315 and one at position 135, to run in a direction and at a speed given by the said motor speed and direction control device to rotate the said blades normally clockwise by 90 degrees in the time it takes to rotate the wind mill normally counterclockwise by 90 degrees and the said speed being governed by the combination of the velocity of rotation of the wind mill plus or minus the velocity of rotation of said weather vane, if any, and wherein the said combination is registered by said small diameter wheel as said small diameter wheel rotates faster or slower and said small diameter wheel will rotate even faster, slower, will stop or reverse direction of rotation depending on the rotation of said weather vane and wherein said small diameter wheel will send the corresponding commands via a motor control center to said variable speed bi-directional electric motors, and when one of said four radial arms reaches position 45 the one of said two switch actuators will trigger one of said four alternate on-off switches to turn two of said variable speed bi-directional electric motors off, one at position 45 and one at position 225 thus halting the rotation of the respective of said blades for the ensuing 90 degree rotation of the wind mill, and, in the rare and abnormal condition when the said weather vane would rotate counterclockwise faster than the wind mill, the heretofore claimed operations would work in reverse by virtue of the said four alternate on-off switches being triggered in the opposite direction to send reversing commands and the said motor speed and direction control device being activated in reverse thus reversing commands of direction to said variable speed bi-directional motors.

6. A wind mill as claimed in claims 3 and 4, whereby, under normal operating conditions when the wind will rotates counterclockwise and when one of said four radial arms reaches position 270 the other of said two directional on-off switch actuators will trigger one of said four directional on-off switches thus switching said bi-directional electric motor that is located at position 270 on, so as to turn in a direction to lower and close said booster curtain located at position 270, and, whereby, under normal operating conditions when the wind mill rotates counter-clockwise and when one of said four radial arms reaches position 90, the one of said two directional on-off switch actuators will trigger one of said four directional on-off switches thus switching said bi-directional electric motor at position 90 on, so as to turn in a direction to raise and open said booster curtain located at position 90, and whereby, in the rare and abnormal condition when the said weather vane would rotate counter-clockwise faster than the wind mill the heretofore claimed operations would work in reverse.
